(19) United States
(12) Patent Application Publication
(10) Pub. No.: US 2020/0245605 A1
(43) Pub. Date: Aug. 6, 2020

(54) DISCREET PEST CONTROL DEVICE

(71) Applicant: VM Products, Inc., Colleyville, TX (US)

(72) Inventors: Ethan VICKERY, Colleyville, TX (US); Jay RASMUSSEN, Colleyville, TX (US)

(21) Appl. No.: 16/733,836

(22) Filed: Jan. 3, 2020

Related U.S. Application Data
(60) Provisional application No. 62/787,811, filed on Jan. 3, 2019.

(51) Int. Cl. A01M 1/14

(52) U.S. Cl. CPC A01M 1/14; A01M 2200/011

(57) ABSTRACT

The present disclosure includes pest control devices for trapping pests. For example, some embodiments of the pest control devices comprise a base having a recessed portion, a lip that projects outwardly from and surrounds the recessed portion, and a lid releasably securable to the base, the lid having a cover portion and one or more support(s). The recessed portion may be configured to receive a glue board having a maximum thickness less than the maximum height of the lip. When the lid is secured to the base and a glue board is disposed on the recessed portion, the support(s) can be disposed on the glue board and the cover portion can be disposed above the lip.

### CROSS-REFERENCE TO RELATED APPLICATIONS

This application claims the benefit of priority to U.S. Provisional Patent Application Ser. No. 62/787,811, filed Jan. 3, 2019, hereby incorporated by reference in its entirety.

### FIELD OF INVENTION

The present invention relates generally to pest management and more particularly, but not by way of limitation, to pest control devices, assemblies and/or components.

### BACKGROUND

Pests such as insects, mice, rats, and other small creatures can cause problems for both residential and commercial buildings and their occupants. There are a variety of ways to deal with infestations of pests.

One way to prevent pests from entering an area is to spray pesticide around the perimeter of a building or in other places where pests are unwanted. However, there are certain industries and business where spraying pesticide is not permitted or desired. For example some pesticides can be harmful to people and can pose dangers in sensitive areas, e.g., where food is prepared, nurseries, hospitals, child service centers, or the like. Additionally, sprays may not be administrable in hard-to-reach areas.

Another way to manage pests in lieu of spraying pesticide is to use pest control devices such as traps. Traps may include a glue or sticky device that traps pests. However, these devices can be unsightly as pests accumulate on the trap. Some traps may be large and/or difficult to install in hard-to-reach places where pests like to travel. And, traps may only be able to capture a limited number of pests, at which point the trap needs to be serviced or replaced. Servicing can be difficult when the trap is located in a hard-to-reach area. Accordingly, there is a need in the art for a discreet pest control device that can be easily serviced and placed in hard-to-reach areas.

### SUMMARY

The present pest control devices and methods of servicing the same address the need for a small and discreet pest control device that is easily serviceable and that may be placed in hard-to-reach areas where pests may reside. Some of the present pest control devices can be configured such that a glue board is attached to a lid thereof and is disposed within a recessed portion of a base of the device to create a deadfall into which pests can fall. Such pest control devices can be serviced by removing the lid from the base to provide easy access to the glue board, which might not otherwise be readily accessible in the recessed portion. The easy access to the glue board facilitates convenient inspection and replacement thereof.

Some of the present pest control devices comprise a base having a recessed portion, which optionally is planar, and a lip that projects outwardly from and surrounds the recessed portion such that the base defines a recess. Some of the present pest control devices have a lid that is releasably securable to the base and has a cover portion and one or more supports that project outwardly from the cover portion. In some of the present pest control devices, the cover portion has a surface that is planar and, optionally, has an area that is between 80% and 95% of the area of the recessed portion. The recessed portion, in some of the present pest control devices, is configured to receive a glue board having a maximum thickness that is less than or equal to 90% of a maximum height of the lip, measured in a direction perpendicular to the recessed portion. In some of the present pest control devices, the lid is configured such that when the glue board is disposed on the recessed portion and the lid is secured to the base, the support(s) are disposed on the glue board and the cover portion is disposed above the lip.

In some of the present pest control devices, each of the support(s) comprises a sidewall that projects outwardly from the cover portion and one or more feet, each extending from the sidewall and having a lower surface such that, when the glue board is disposed on the recessed portion and the lid is secured to the base, the lower surface is disposed on the glue board and is substantially parallel to the recessed portion.

In some of the present pest control devices, for each of the support(s) the one or more feet are disposed above a lower surface of the sidewall such that, when the glue board is disposed on the recessed portion and the lid is secured to the base, the lower surface of the sidewall is disposed on the recessed portion.

In some of the present pest control devices, the cover portion comprises a periphery having two widthwise edges extending in a first direction, two lengthwise edges extending in a second direction perpendicular to the first direction, and four corners, each of which connects one of the widthwise edges to one of the lengthwise edges. In some of the present pest control devices, for at least one of the support(s), the sidewall extends along at least a portion of the periphery. Each of the widthwise and lengthwise edges, in some of the present pest control devices, is linear.

In some of the present pest control devices, the one or more supports comprise two or more supports and, for each of at least first and second ones of the supports, the sidewall extends along at least one of the corners such that, along at least a portion of at least one of the lengthwise edges, the lid defines a gap between the first and second supports.

In some of the present pest control devices, for each of the first and second supports, the sidewall extends along a respective one of the widthwise edges, two of the corners, and a portion of each of the lengthwise edges such that, along a portion of each of the lengthwise edges, the lid defines a gap between the first and second supports.

The one or more feet, in some of the present pest control devices, comprise two or more feet for each of the first and second supports.

In some of the present pest control devices, the cover portion defines one or more openings and, optionally, each of the opening(s) is disposed over a respective one of the one or more feet. In some of the present pest control devices, each of the opening(s) has an area that is within 10% of the area of the lower surface of the foot over which the opening is disposed. In some of the present pest control devices, the one or more openings comprise four or more openings and, for each of at least four of the openings, at least a portion of the opening is defined by a respective one of the corners of the periphery.

In some of the present pest control devices, the cover portion and the sidewall(s) are unitary.

In some of the present pest control devices, the base comprises one or more tabs, optionally two or more tabs, and the lid comprises one or more receptacles, optionally two or more receptacles, each configured to receive a respective one of the tab(s) to secure the lid to the base. Each of the tab(s), in some of the present pest control devices, projects outwardly from the lip. Each of the receptacle(s), in some of the present pest control devices, is coupled to a respective one of the widthwise edges.

In some of the present pest control devices, the recessed portion comprises opposing upper and lower surfaces, where the upper surface is disposed within the recess and an adhesive is disposed on the lower surface.

In some of the present pest control devices, the glue board is disposed on the recessed portion and the lid is secured to the base such that the support(s) are adhered to the glue board.

Some of the present methods for servicing pest control devices comprise removing the lid and the glue board from the base. In some of the present methods, the glue board is disposed on the recessed portion and the lid is secured to the base such that the support(s) are adhered to the glue board and the glue board remains adhered to the lid during the removing. The glue board, in some of the present methods, is a first glue board. Some of the present methods comprise removing the first glue board from the lid; adhering a second glue board to the support(s) of the lid; and securing the lid to the base such that the second glue board is disposed on the recessed portion.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale, unless otherwise noted, meaning that in each of the figures the sizes of the elements are accurate relative to each other at least for the depicted embodiment.

FIG. 1A is a perspective view of a first embodiment of a pest control device.

FIGS. 1B and 1C are perspective views of the base and lid, respectively, of the pest control device of FIG. 1A when the base and lid are not coupled together.

FIG. 1D is an exploded view of the pest control device of FIG. 1A.

FIGS. 1E and 1F are top and bottom views, respectively, of the pest control device of FIG. 1A.

FIGS. 1G-1J are front, back, left, and right views, respectively, of the pest control device of FIG. 1A.

FIG. 1K is a perspective, cross-sectional view of the pest control device of FIG. 1A taken along line 1K-1K of FIG. 1C.

FIG. 1L is a cross-sectional view of the pest control device of FIG. 1A taken along line 1L-1L of FIG. 1C.

FIG. 2 is a perspective view of a second embodiment of a pest control device having an opening defined at the center of the device's cover portion.

FIG. 3A is a top view of a third embodiment of a pest control device in which lip has a convex surface connected to the recessed portion and the tabs have a projection configured to engage the receptacles.

FIG. 3B is a sectional view of the pest control device of FIG. 3A taken along line 3B-3B.

FIG. 3C is an enlarged, partial sectional view of the pest control device of FIG. 3A.

FIGS. 4A-4D are front views of a pest control device illustrating some of the present methods of servicing the device. FIGS. 4A and 4B illustrate removal of a first glue board from the device and FIGS. 4C and 4D illustrate replacement of the first glue board with a second glue board.

### DETAILED DESCRIPTION OF ILLUSTRATIVE EMBODIMENTS

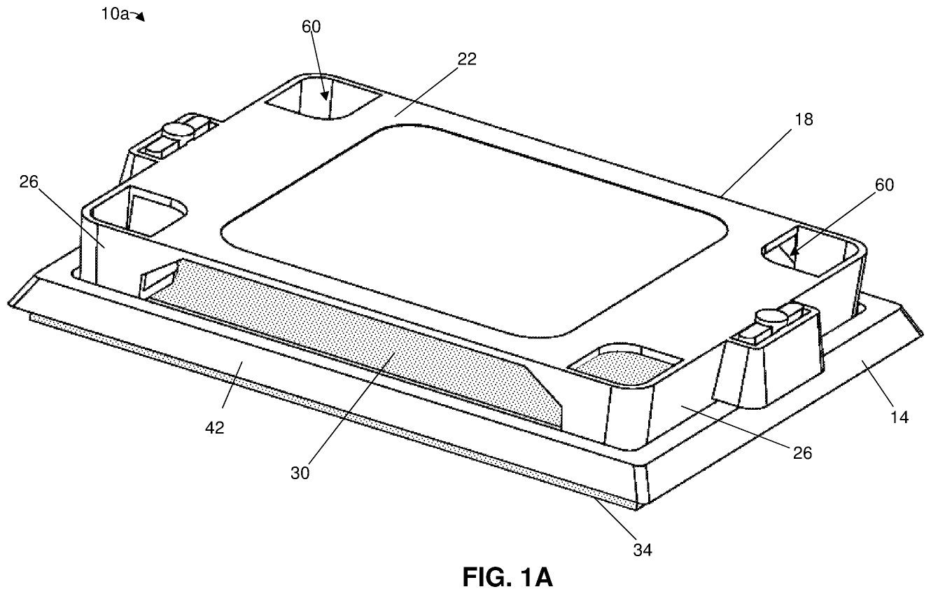

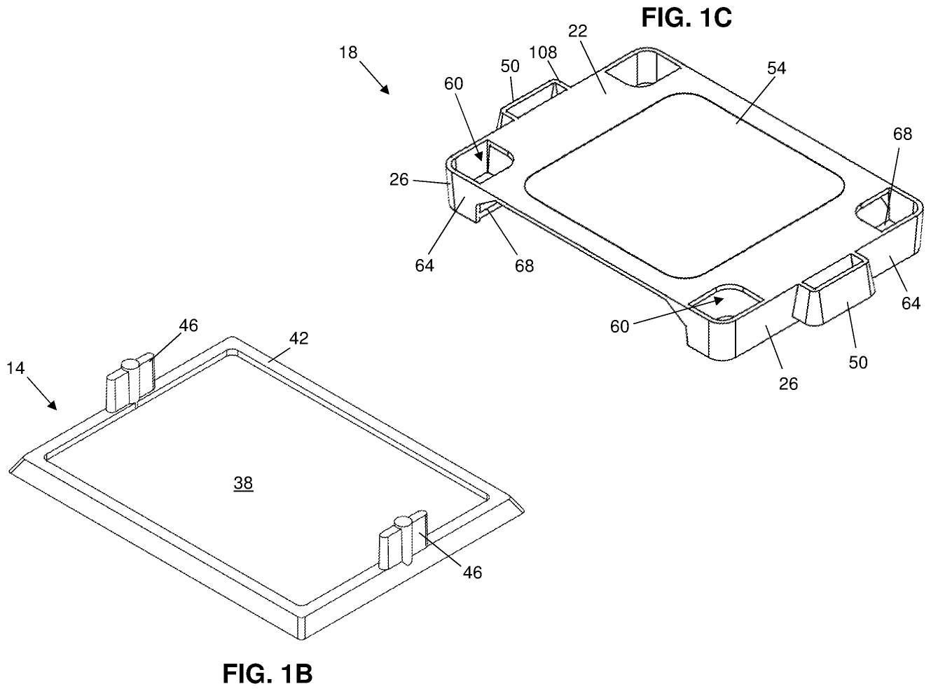

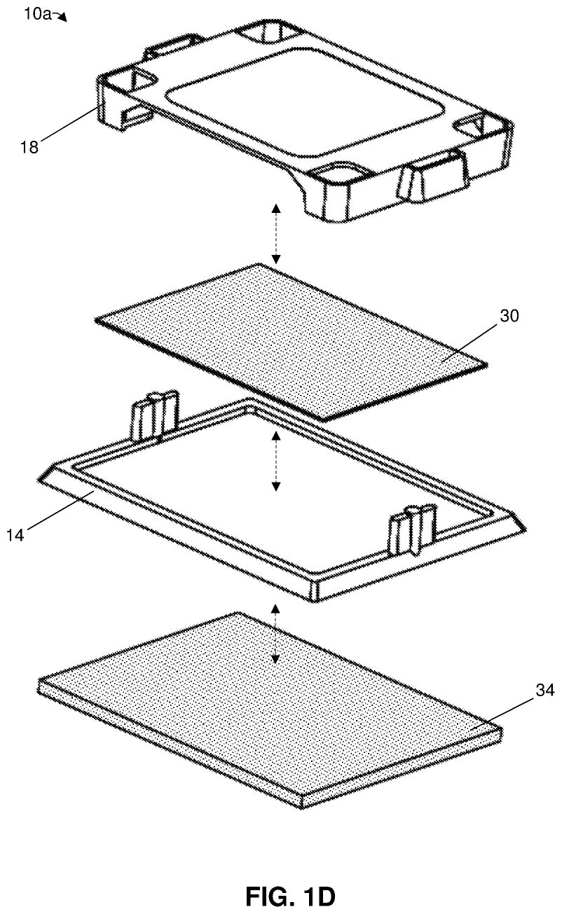

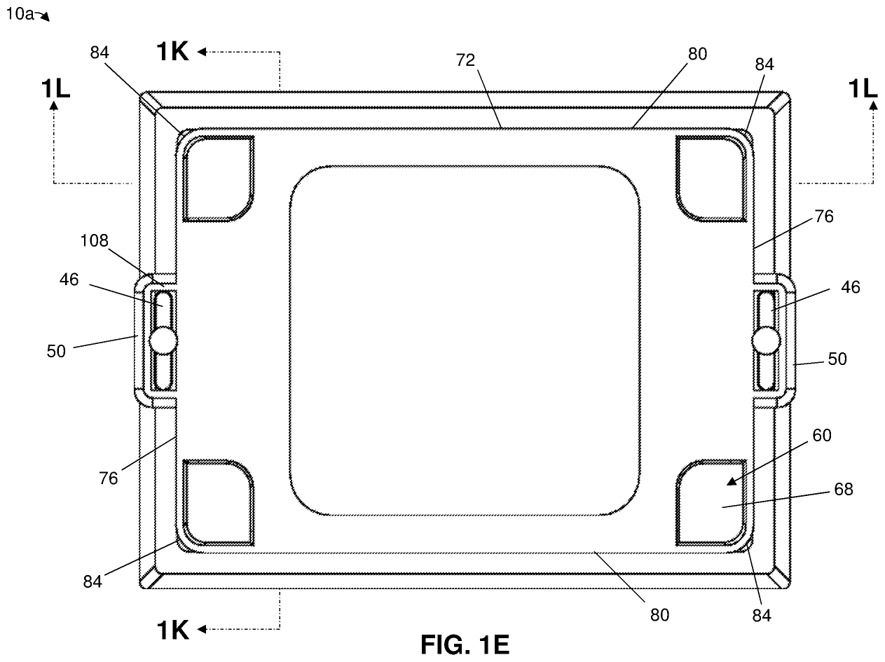

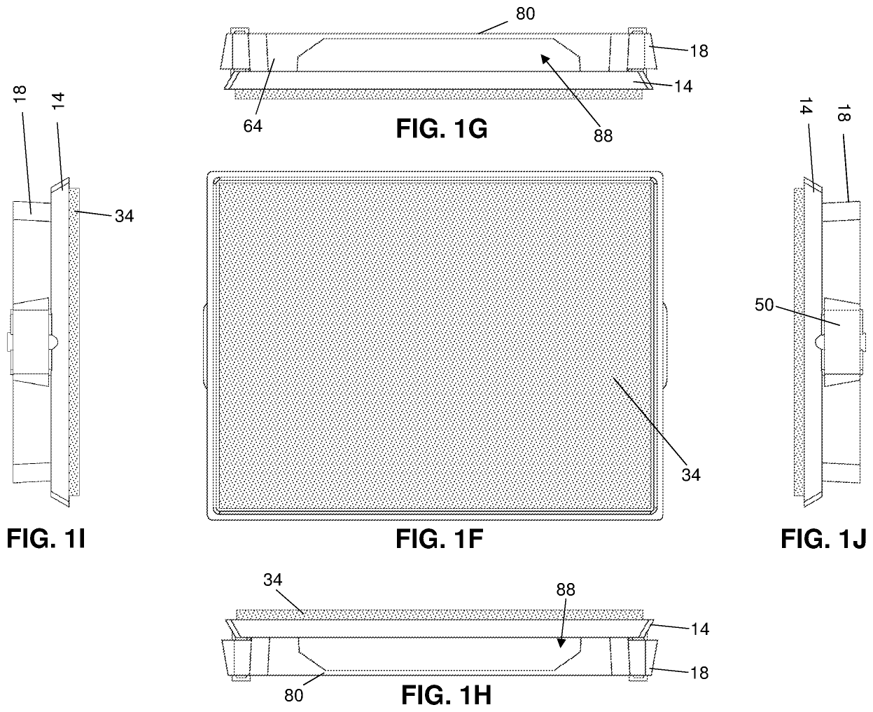

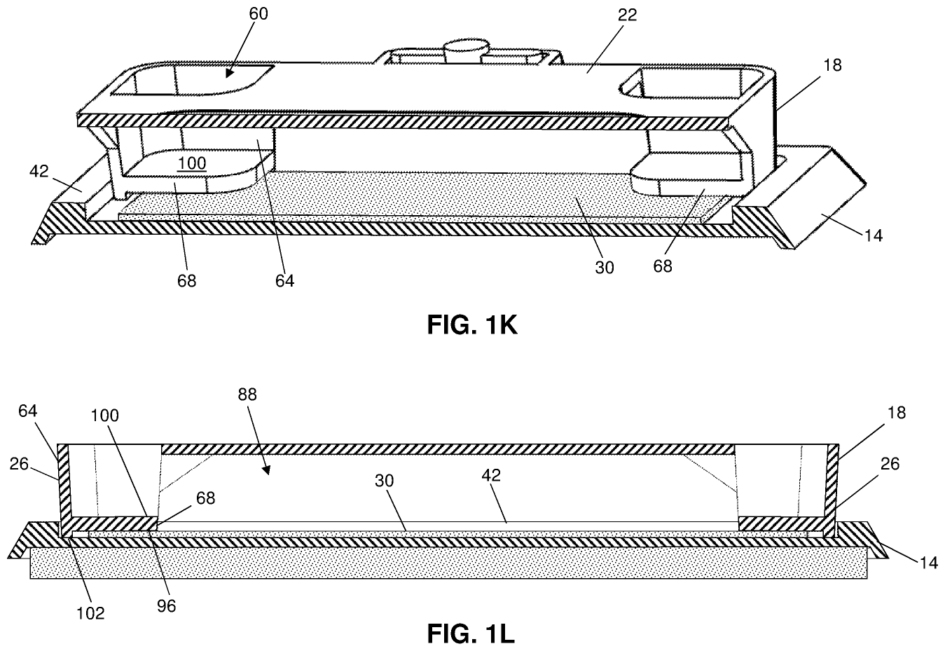

Referring to FIGS. 1A-1L, shown is an embodiment 10a of the present pest control devices. Device 10a can comprise a base 14 and a lid 18 that is releasably securable to the base. Device 10a can be configured to receive, and in some embodiments can comprise, a glue board 30 that can be coupled to lid 18 and/or base 14. For example, base 14 can comprise a recessed portion 38, which can be planar and can have opposing upper and lower surfaces, and a lip 42 that projects outwardly from and surrounds (e.g., at least a majority or all of) the recessed portion to define a recess in the base. Glue board 30 can be received by recessed portion 38 (e.g., on the upper surface thereof) such that lip 42 surrounds the glue board, and can comprise an adhesive such that pests (e.g., insects, mice, and/or rats) that enter onto the adhesive of the glue board become trapped thereon. A maximum thickness of glue board 30 can be less than a maximum height of lip 42, measured in a direction perpendicular to recessed portion 38, e.g., to facilitate trapping of insects. For example, the maximum thickness of glue board 30 can be less than or equal to or between any two of 90%, 80%, 70%, 60%, 50%, 40%, 30%, or less of the maximum height of lip 42.

Lid 18 can comprise a cover portion 22, which can be planar (e.g., as shown), and one or more supports 26 that project outwardly from the cover portion. For example, lid 18 can comprise greater than or equal to or between any two of 1, 2, 3, 4, 5, 6, or more supports 26; as shown, the lid has two supports. Cover portion 22 can display a logo, emblem, mark or other design feature (e.g., in depression 54, as shown). For example, cover portion 22 (or another portion of lid 18) can display a bar code that can be scanned by a technician to log service of device 10a. When lid 18 is secured to base 14 and glue board 30 is disposed on recessed portion 38, support(s) 26 can be disposed on the glue board, and optionally on the base (e.g., such that the support(s) are surrounded by lip 42). Accordingly, support(s) 26 can be adhered to glue board 30 such that the glue board remains attached to lid 18 when the lid is removed from base 14, thereby facilitating removal of the glue board for inspection and replacement thereof. For example, removing lid 18 (and thus glue board 30) from base 14 can provide convenient access to the glue board, which might not otherwise be readily accessible when disposed in recessed portion 38. This configuration facilitates service by a technician, who can remove glue board 30 from lid 18 when the lid is detached from base 14, couple a replacement glue board to the lid, and reattach the lid with the replacement glue board to the base to trap additional pests.

To illustrate, each of support(s) 26 can comprise a sidewall 64 that projects outwardly from cover portion 22 (e.g., such that an angle defined between the sidewall and the cover portion is less than or equal to, or between any two, 90°, 80°, 70°, 60°, 50°, 40°, 30°, or less) and one or more feet 68 having opposing lower and upper surfaces 96 and 100. At least one of, or both of, lower and upper surfaces 96 and 100 can, but need not, be planar. Each of support(s) 26 can comprise greater than or equal to or between any two of 1, 2, 3, 4, 5, 6 or more feet; as shown, for example, each of supports 26 has two feet 68. For each of support(s) 26, each of one or more feet 68 can extend from sidewall 64 (e.g., toward a center of device 10a) such that lower surface 96 is substantially parallel to recessed portion 38 and is disposed on and adhered to glue board 30. For each of support(s) 26, each of one or more feet 68 may be disposed above a lower surface 102 of sidewall 64 such that, when lid 18 is secured to base 14 and glue board 30 is disposed on recessed portion 38, the lower surface of the sidewall is disposed on the recessed portion (e.g., not on the glue board) to facilitate secure placement of the lid on the base.

A surface of glue board 30 disposed on the upper surface of recessed portion 38 can, but need not, be free of adhesive to facilitate the glue board's removability from base 14. Support(s) 26, when lid 18 is secured to base 14, can secure glue board 30 against the upper surface of recessed portion 38 to prevent the glue board from falling off of the base.

Cover portion 22 can be shaped and support(s) 26 can be positioned to facilitate gripping, and thus removal, of lid 18. Cover portion 22, for example, can be triangular, rectangular, square, or otherwise polygonal (whether having sharp and/or rounded corners), circular, elliptical, or otherwise rounded, or can have an irregular shape. As shown, a periphery 72 of cover portion 22 can have two widthwise edges 76 (which can, but need not, be linear) extending in a first direction, two lengthwise edges 80 (which can, but need not, be linear) extending in a second direction that is perpendicular to the first direction, and four corners, each of which connects one of the widthwise edges to one of the lengthwise edges. Each of corners 84 can be concave, convex, sharp, or can have any other suitable shape such that the corner connects one of widthwise edges 76 to one of lengthwise edges 80.

For at least one of support(s) 26, sidewall 64 can extend along at least a portion of (e.g., greater than or equal to or between any two of 20%, 30%, 40%, 50%, 60%, 70%, 80%, 90%, or more of) periphery 72. For example, as shown, for each of at least first and second ones of supports 26, sidewall 64 can extend along at least one of, optionally two of, corners 84, a respective one of widthwise edges 76, and/or a portion of each of lengthwise edges 80. Lid 18 can define one or more gaps 88 having any suitable shape; for example, the lid can define a gap along at least a portion of at least one of (e.g., each of) lengthwise edges 80 (e.g., between first and second supports 26). Lid 18 can be easily gripped by a technician via gap(s) 88 to facilitate removal and securement of the lid to base 14. Pests may also be able to enter device 10a via gap(s) 88, where the pests can become trapped on glue board 30.

Lid 18 can be releasably secured to base 14 via any suitable means, such as, for example, via adhesive, mechanical fastener(s), a snap fit, hook and loop fastener(s), latch(es), and/or the like. To illustrate, base 14 can comprise one or more tabs 46, such as, for example, greater than or equal to or between any two of 1, 2, 3, 4, 5, 6, or more (e.g., greater than or equal to 2) tabs; as shown, the base has two tabs. Each of tab(s) 46 can project outwardly from lip 42, optionally such that when the lid 18 is secured to base 14 a portion of the tab(s) is disposed above cover portion 22; in other embodiments, however, the tab(s) can be positioned at any suitable location on the base, e.g., on recessed portion 38 such that the tab(s) can project outwardly therefrom. Lid 18 can comprise one or more receptacles 50, such as, for example, greater than or equal to or between any two of 1, 2, 3, 4, 5, 6, or more (e.g., greater than or equal to 2) receptacles (e.g., one for each of tab(s) 46); as shown, the lid has two receptacles. In other embodiments, base 14 can comprise receptacle(s) 50 and lid 18 can comprise tab(s) 46.

Each of receptacle(s) 50 can be configured to receive a respective one of tab(s) 46 to releasably secure lid 18 to base 14. For example, each of receptacle(s) 50 may define a channel (e.g., the receptacle can be U-shaped) through which a respective one of tab(s) 46 can extend. Each of receptacle(s) 50 can be tapered such that the cross-sectional area of the receptacle's channel decreases moving from a lower portion of the receptacle to an upper portion of the receptacle that is disposed closer to cover portion 22 than is the lower portion (or if the receptacle is disposed on the base, the tapering can be such that the cross-sectional area decreases moving from the upper portion to the lower portion). The tapering of each of receptacle(s) 50 can facilitate securement of tab(s) 46 therein, and thus of lid 18 to base 14.

Each of receptacle(s) 50 may extend outwardly from support(s) 26 of lid 18, e.g., from one of widthwise edges 76 and/or lengthwise edges 80 such that at least one of the widthwise and lengthwise edges comprises one or more of the receptacle(s). As shown, for example, each of receptacles 50 is coupled to a respective one of widthwise edges 76. When lid 18 is secured to base 14, each of receptacle(s) 50 can be disposed on lip 42 of base 14 and, optionally, an upper surface 108 of the receptacle can be substantially planar with cover portion 22.

Device 10a can comprise an adhesive backing 34 coupled to base 14. For example, adhesive backing 34 can be coupled to and underlie at least a portion (e.g., at least a majority or all) of the lower surface of recessed portion 38. Device 10a can be coupled to an object via adhesive backing 34, such as, for example, to a floor, wall, ceiling, cabinet, desk, or any suitable structure. To illustrate, adhesive backing 34 can comprise an (e.g., double-sided) adhesive foam (e.g., a closed-cell PE foam tape with acrylic adhesive), with one side adhered to the lower surface of recessed portion 38 and the other side configured to be adhered to an object. Optionally, a removable protective layer can be disposed on adhesive backing 34 to protect the adhesive backing before use; the protective layer can be removed to expose the adhesive backing for securement to an object. When device 10a is secured to an object via adhesive backing 34, lid 18 and glue board 30 can be removed from base 14 while the base remains attached to the object.

When glue board 30 is disposed on recessed portion 38 and lid 18 is secured to base 14, cover portion 22 can be disposed above lip 42 and overlie at least a portion of the recessed portion. For example, a surface of cover portion 22 can have an area that is greater than or equal to or between any two of 50%, 60%, 70%, 80%, 90%, 100%, or more (e.g., between 80% and 95%) of the area of recessed portion 38. Cover portion 22 can define one or more openings 60 through which a pest (e.g., an insect, mouse, or rat) can fall onto base 14, where the pest can be trapped by glue board 30. For example, cover portion 22 can define greater than or equal to or between any two of 1, 2, 3, 4, 5, 6, 7, 8 or more openings; as shown, the cover portion defines four openings.

Each of opening(s) 60 can be disposed over a respective one of one or more feet 68 such that upper surface 100 of the foot is configured to receive a pest that falls through the opening. A pest that falls through one of these opening(s) 60 onto a foot 68 disposed below the opening may not immediately contact glue board 30, thereby preventing the accumulation of pests under the opening. For example, an area of each of opening(s) 60 can be within 10% of the area of upper surface 100 of a foot 68 disposed under the opening. Such a configuration can permit pests to reach a larger portion of glue board 30 to be trapped thereon, thereby promoting a greater dispersion of pests on the glue board to facilitate capture of multiple pests. As such, device 10a can be serviced less often than conventional pest control devices.

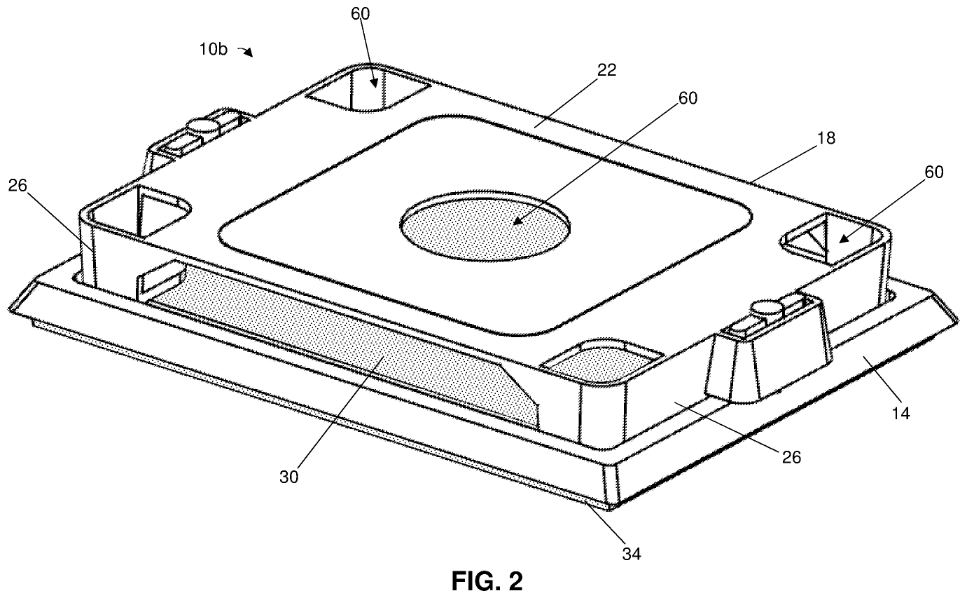

Opening(s) 60 can be arranged in any suitable manner. While, as shown, device 10a comprises four openings 60, each of which is at least partially defined by a respective one of corners 84 of periphery 72 and is disposed over a respective one of feet 68, in other embodiments at least one of opening(s) 60 can be positioned such that an insect that falls through the opening can land directly on glue board 30 and/or can be positioned away from periphery 72 (e.g., the opening can be separated from each of lengthwise and widthwise edges 76 and 80 by a distance than is at least 10% of the length of each of the lengthwise and widthwise edges). For example, referring to FIG. 2, shown is a pest control device 10b that is substantially similar to device 10a, the primary exception being that one of openings 60 of device 10b is defined at the center of cover portion 22. As shown, the other ones of openings 60 are arranged as described above with respect to device 10a, e.g., at least some of the openings can be defined at periphery 72 and at least some of the openings can be defined away from the periphery.

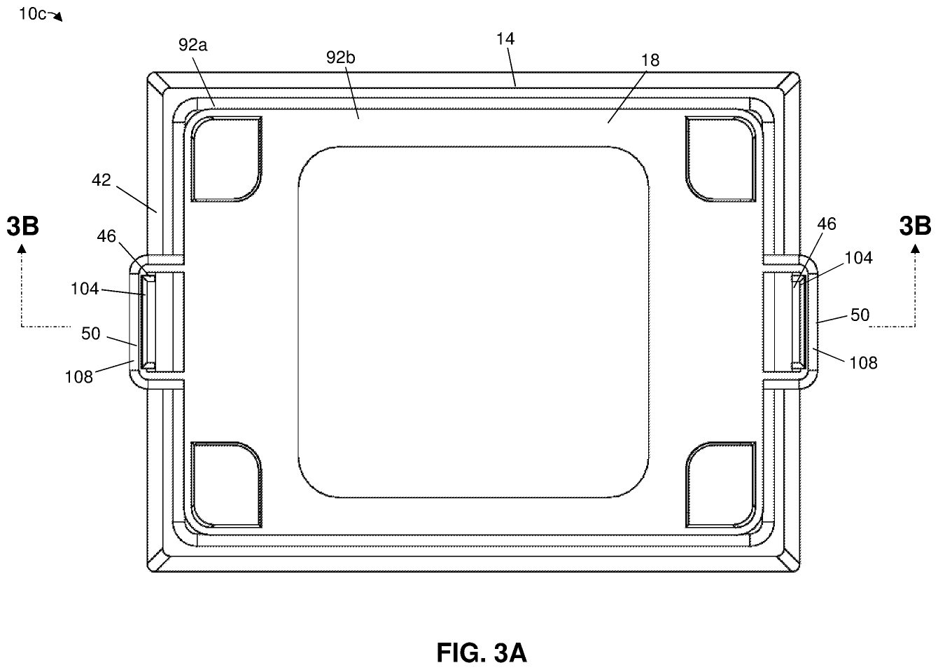

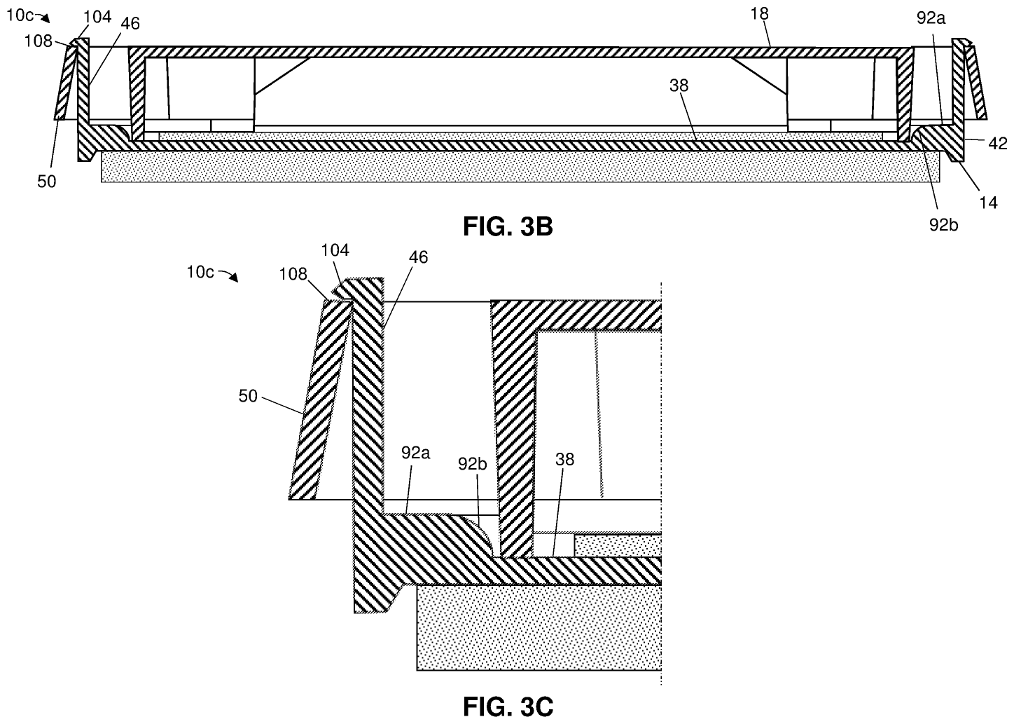

Referring to FIGS. 3A-3C, shown is a pest control device 10c that is substantially similar to device 10a, the primary exception being the shapes of lip 42 and tabs 46. As shown, a surface of lip 42 can have a first portion 92a disposed at a height above recessed portion 38 and a second portion 92b that connects the first portion to the recessed portion. First portion 92a can, but need not, be planar (e.g., parallel with recessed portion 38) and second portion 92b can be convex (e.g., arcuate); such a shape can facilitate capture and retention of pests (e.g., bed bugs). Each of tabs 46 can comprise a projection 104 oriented such that, when lid 18 is secured to base 14, the projection is disposed on upper surface 108 of receptacle 50 to facilitate retention of the lid on the base. Tabs 46 can be bendable (e.g., inwardly toward recessed portion 38) to facilitate releasable securement of lid 18; for example, as the lid is placed on base 14, each of receptacles 50 may exert a force on a respective one of the tabs to bend the tab and, when projection 104 exits the channel defined by the receptacle, the tab can return to its original position such that the projection overlies and engages upper surface 108. To remove lid 18 from base 14, each of tabs 46 can be configured to disengage receptacle 50 at least by bending the tab such that projection 104 is not disposed on upper surface 108, thereby allowing the tab to pass through the channel defined by the receptacle.

Devices (e.g., 10a-10c) of the present disclosure, and the component(s) thereof, can have any suitable construction. For example, each of base 14 and/or lid 18 can comprise a polymer, metal, wood, and/or any other suitable material. To illustrate, base 14 and/or lid 18 can comprise a polymer, such as, for example, polypropylene (PP), polystyrene (PS), high impact polystyrene (HIPS), acrylonitrile butadiene styrene (ABS), polyethylene terephthalate (PET), polyvinyl chloride (PVC), polycarbonate (PC), polyethylene (PE), polycarbonate/acrylonitrile butadiene styrene (PC/ABS), polycarbonate polybutylene terephthalate (PBT), acrylonitrile styrene acrylate (ASA), a polyurethane, nylon (often referred to as polyamide (PA)), and/or the like. One or more components of the pest control device can be unitary (e.g., each of base 14 and/or lid 18 can be molded) or can comprise separate pieces connected together. For example, cover portion 22, each of sidewall(s) 64, each of one or more feet 68, and/or receptacle(s) 50 can, but need not, be unitary. Tab(s) 46, lip 42, and/or recessed portion 38 also can, but need not, be unitary.

Some devices can be provided as an assembly, e.g., in which glue board 30 is disposed on recessed region 38 and lid 18 is secured to base 14 such that support(s) 26 are adhered to the glue board.

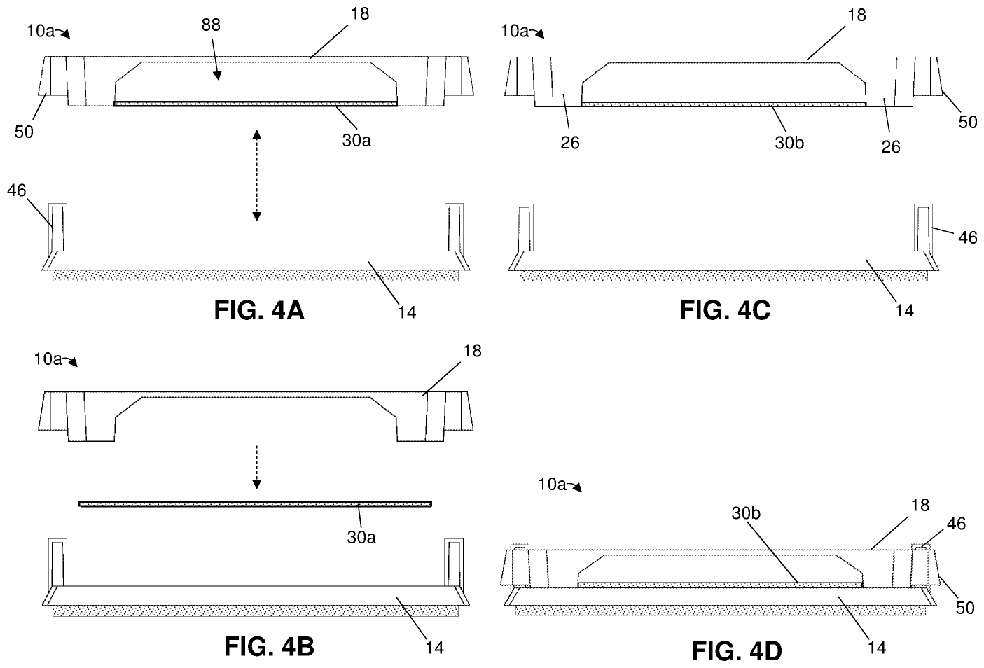

Referring to FIGS. 4A-4D, illustrated are some of the present methods for servicing a pest control device (e.g., 10a, 10b, or 10c). As shown, a first glue board (e.g., 30a) can be disposed on a recessed region (e.g., 38) of the device's base (e.g., 14) and the device's lid (e.g., 18) can be releasably secured to the base such that support(s) (e.g., 26) of the lid are adhered to the first glue board. A plurality of pests (e.g., insects, mice, and/or rats) may be trapped on the first glue board, which may warrant replacement thereof. To do so, some methods comprise a step of removing the lid and the first glue board from the base such that the first glue board remains adhered to the lid during the removing (FIG. 4A). The removing may be performed, for example, by pulling the lid away from the base such that tab(s) (e.g., 46) of the base disengage receptacle(s) (e.g., 50) of the lid.

Some methods comprise a step of removing the first glue board from the lid (FIG. 4B). The first glue board can be removed from the lid by, for example, inserting a portion of a finger in a gap (e.g., 88) defined by the lid and prying the first glue board away from the lid. After the removing, some methods comprise a step of adhering a second glue board (e.g., 30b) to the support(s) of the lid (e.g., to each of one or more feet (e.g., 68) and/or sidewall(s) (e.g., 64) of the lid) (FIG. 4C).

To reset the device to capture additional pests, some methods comprise a step of securing the lid to the base such that the second glue board is disposed on the recessed portion (FIG. 4D). The securing can be performed such that each of the tab(s) is received by a respective one of the receptacle(s) and, optionally, such the support(s) are disposed on the recessed portion.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A pest control device comprising:
a base having a recessed portion and a lip that projects outwardly from and surrounds the recessed portion such that the base defines a recess; and
a lid that is releasably securable to the base and has a cover portion and one or more supports that project outwardly from the cover portion;
where:
the recessed portion is configured to receive a glue board having a maximum thickness that is less than or equal to 90% of a maximum height of the lip, measured in a direction perpendicular to the recessed portion; and
the lid is configured such that when the glue board is disposed on the recessed portion and the lid is secured to the base, the support(s) are disposed on the glue board and the cover portion is disposed above the lip.

2. The pest control device of claim 1, where each of the support(s) comprises:
a sidewall that projects outwardly from the cover portion; and
one or more feet, each extending from the sidewall and having a lower surface such that, when the glue board is disposed on the recessed portion and the lid is secured to the base, the lower surface is disposed on the glue board and is substantially parallel to the recessed portion.

3. The pest control device of claim 2, where for each of the support(s) the one or more feet are disposed above a lower surface of the sidewall such that, when the glue board is disposed on the recessed portion and the lid is secured to the base, the lower surface of the sidewall is disposed on the recessed portion.

4. The pest control device of claim 2, where:
the cover portion comprises a periphery having:
two widthwise edges extending in a first direction;
two lengthwise edges extending in a second direction perpendicular to the first direction; and
four corners, each of which connects one of the widthwise edges to one of the lengthwise edges; and
for at least one of the support(s), the sidewall extends along at least a portion of the periphery.

5. The pest control device of claim 4, where each of the widthwise and lengthwise edges is linear.

6. The pest control device of claim 4, where:
the one or more supports comprise two or more supports; and
for each of at least first and second ones of the supports, the sidewall extends along at least one of the corners such that, along at least a portion of at least one of the lengthwise edges, the lid defines a gap between the first and second supports.

7. The pest control device of claim 6, where for each of the first and second supports the sidewall extends along a respective one of the widthwise edges, two of the corners, and a portion of each of the lengthwise edges such that, along a portion of each of the lengthwise edges, the lid defines a gap between the first and second supports.

8. The pest control device of claim 6, where for each of the first and second supports the one or more feet comprise two or more feet.

9. The pest control device of claim 1, where the cover portion defines one or more openings.

10. The pest control device of claim 2, where:
the cover portion defines one or more openings; and
each of the opening(s) is disposed over a respective one of the one or more feet.

11. The pest control device of claim 10, where each of the opening(s) has an area that is within 10% of the area of the lower surface of the foot over which the opening is disposed.

12. The pest control device of claim 9, where:
each of the support(s) comprises:
a sidewall that projects outwardly from the cover portion; and
one or more feet, each extending from the sidewall and having a lower surface such that, when the glue board is disposed on the recessed portion and the lid is secured to the base, the lower surface is disposed on the glue board and is substantially parallel to the recessed portion;
the cover portion comprises a periphery having:
two widthwise edges extending in a first direction;
two lengthwise edges extending in a second direction perpendicular to the first direction; and
four corners, each of which connects one of the widthwise edges to one of the lengthwise edges; and
for at least one of the support(s), the sidewall extends along at least a portion of the periphery;
the one or more openings comprise four or more openings; and
for each of at least four of the openings, at least a portion of the opening is defined by a respective one of the corners of the periphery.

13. The pest control device of claim 1, where the cover portion is planar.

14. The pest control device of claim 1, where a surface of the cover portion has an area that is between 80% and 95% of the area of the recessed portion.

15. The pest control device of claim 1, where the cover portion and the sidewall(s) are unitary.

16. The pest control device of claim 1, where:
the base comprises one or more tabs; and
the lid comprises one or more receptacles, each configured to receive a respective one of the tab(s) to secure the lid to the base.

17. The pest control device of claim 4, where:
the base comprises two or more tabs, each projecting outwardly from the lip; and
the lid comprises two or more receptacles, each coupled to a respective one of the widthwise edges and configured to receive a respective one of the tabs to secure the lid to the base.

18. The pest control device of claim 1, where:
the recessed portion comprises opposing upper and lower surfaces, the upper surface disposed within the recess; and
an adhesive backing is disposed on the lower surface of the recessed portion.

19. The pest control device of claim 1, comprising the glue board, where the glue board is disposed on the recessed portion and the lid is secured to the base such that the support(s) are adhered to the glue board.

20. A method of servicing a pest control device that includes a base having a recessed portion, a first glue board disposed on the recessed portion, and a lid secured to the base such that one or more supports of the lid that project outwardly from a cover portion of the lid are adhered to the glue board, the method comprising:
removing the lid and the first glue board from the base such that the first glue board remains adhered to the lid during the removing;
removing the first glue board from the lid;
adhering a second glue board to the support(s) of the lid; and
securing the lid to the base such that the second glue board is disposed on the recessed portion, the support(s) are disposed on the second glue board, and the cover portion is disposed above a lip of the lid that projects outwardly from and surrounds the recessed portion such that the base defines a recess;
where each of the first and second glue boards has a maximum thickness that is less than or equal to 90% of a maximum height of the lip, measured in a direction perpendicular to the recessed portion.
